(19) United States
(12) Patent Application Publication
(10) Pub. No.: US 2009/0200115 A1
(43) Pub. Date: Aug. 13, 2009

(54) Lubrication of Sail Edge Channels

(76) Inventors: Keith Williams, Esstleigh (GB); Charles Jeremy Hannah, New Milton (GB)

Correspondence Address: Nguyen & Tarbet, 6039 E. Grant Rd., Tucson, AZ, 85712, US

(21) Appl. No.: 12/188,097

(22) Filed: Aug. 7, 2008

(30) Foreign Application Priority Data
Aug. 8, 2007 (GB) GB 0715322.4

(51) Int. Cl. F16N 1/00; B63B 17/00; B63H 9/08

(52) U.S. Cl. 184/100; 114/221 R; 114/108

(57) ABSTRACT

The device lubricates a sail edge channel, such as a luff channel in a luff channel extrusion fitted to a forestay of a sloop. The device comprises a slide arranged for insertion into and for sliding along the channel and a reservoir for containing a lubricant. A web connects the slide to the reservoir and extends from the slide out of the sail edge channel so that the slide can slide in the channel with the reservoir outside the sail edge channel. A passageway extends from the reservoir and through the web to at least two outlets from the slide arranged at different angular positions around the slide. The lubricant can be expelled from the reservoir into the passageway so that the lubricant is expelled from the outlets into the sail edge channel.

### BACKGROUND OF THE INVENTION

1. Field of the Invention

This invention relates to the lubrication of sail edge channels. Although the invention was originally conceived in connection with lubrication of a channel in a luff channel extrusion for the luff of a head sail of a sloop, it is also applicable to the lubrication of other sail edge channels, such as a channel in a mast for the luff of a mainsail, a channel in a boom for the foot of a mainsail, or a channel in a reefing roller for the luff of a headsail.

### BACKGROUND OF THE INVENTION

2. Background Art

Referring to FIGS. 1 to 3 of the accompanying drawings, a sailing vessel in the form of a sloop 10 has a mast 12 stepped on a hull 14 and held by a forestay 16 and shrouds 18. A mainsail 20 has its luff 22 or luff runners inserted into a luff channel 24 (FIG. 2) in the mast 12, and its foot edge attached to a boom 26 controlled by a main sheet 28. A headsail 30, such as a jib or genoa, has its luff 32 attached to the forestay 16 and is controlled by a sheet 34. Traditionally, the luff 32 of the headsail 30 would be attached to the forestay 16 by a series of clips. However, for high-performance racing vessels, it is now popular to fit a luff channel extrusion 36 to the forestay 16 to provide undisturbed airflow along the luff 32 of the headsail 30 and to enable fast changing of headsails. An example of such a luff channel extrusion 36 is sold under the name Tuff Luff and is used on America's Cup and Whitbread vessels.

Referring in particular to FIG. 3, an example of luff channel plastics extrusion 36 has a main channel 38 into which the forestay 16 can be forced through a slit 40. The sides of the main channel 38 are bounded to either side of the slit 40 by respective luff channels 42A,42B that can receive the luff 32 of the sail 30. Each luff channel 42A,42B has a respective slit 44A,44B through which the material of the sail 30 exits the channel 42A,42B from the luff 32. Such a luff channel extrusion therefore enables headsails 30 be quickly hoisted up and dropped down the forestay 16. The provision of two luff channels 42A,42B enables one sail 30 in one of the luff channels, e.g. 42A, to be dropped while another sail is hoisted up the other luff channel, e.g. 42B, to facilitate further the fast changing of headsails. Although not shown in the drawings, the lower end of the luff channel extrusion 36 may be provided with a guide device to facilitate feeding of the luff 32 of a sail 30 into the channels 42A,42B.

A problem with such luff channels extrusions 36 is that there can be a tendency for the luff 32 to snag in the luff channel 42. When snagging occurs, it may be possible to free it by pulling hard downwards on the luff 32 or by pulling hard upwards using the headsail halyard 46. However, in some cases, it may be necessary for a crew member to be hoisted up the mast 22, to swing over to the forestay 16, and to manipulate the luff 16 in the luff channel 42 at the point where the snag has occurred. All of this can take valuable time during a race. To reduce the risk of snagging, it is common for the luff-channels 42A,42B to be lubricated before a race. This is done by completely, or almost completely, removing the luff channel extrusion 36 from the forestay 16, squirting lubricant from an aerosol through the slits 44A,44B into the luff-channels 42A,42B along the length of the luff-channels 42A,44B, and then replacing the luff-channel extrusion 36 on the forestay 16. Typically, a silicone or PTFE-based grease is used. An example is sold under the name Sailcote. Lubrication of the luff-channels 42A,42B is time consuming. Also, each time the forestay 16 is forced through the slit 40, there is a risk of damaging the luff-channel extrusion 36 either by breakage or by kinking, which will further exacerbate the snagging problem unless the luff-channel extrusion is then completely replaced. Furthermore, in the case of a long race with many sail changes, snagging of the sail luffs 32 in the luff-channels 42A,42B may still occur, despite lubrication of the luff-channels 42A,42B before the race.

Patent document U.S. Pat. No. 5,535,695 discloses an apparatus for lubricating a sail edge channel of a spar such as a mast, boom or gaff. The apparatus has a pair of guide members that can be inserted into the sail edge channel and are connected to a plate outside the channel so that the plate can be slid along the spar. An aerosol of lubricant is mounted on the other side of the plate to the guide members and can be operated to squirt a jet of lubricant from its nozzle through a hole in the plate and into the sail edge channel as the apparatus is slid along the spar. A first problem associated with this apparatus is that the aerosol nozzle needs to be accurately lined-up with the sail edge channel, but even if it is, if the wind is blowing, the lubricant jet can be blown off course so that it does not enter the sail edge channel and even does not pass through the hole in the plate. A second problem is that, even if the lubricant does enter the sail edge channel, it is directed against the root of the sail edge channel (the portion furthest from the channel opening), which is where the lubricant is least required. Furthermore, lubricant which is directed at the root of the sail edge channel will tend to be reflected straight back out of the sail edge channel and wasted.

Patent document DE10107739A1 discloses a somewhat similar apparatus, except that the aerosol nozzle is fitted with a straight spray tube which, in use, conveys the lubricant from the nozzle to the sail edge channel. This apparatus suffers from the same problem as with U.S. Pat. No. 5,535,695 that the lubricant entering the sail edge channel is directed against the root of the sail edge channel, where it is least required, and tends to be reflected straight back out of the channel. Furthermore, spray tubes of the sort shown in DE10107739A1 can typically be easily dislodged from the nozzle. Moreover, spray tubes of the sort shown in DE10107739A1 are typically flexible, so that if the spray tube is knocked, it can be displaced from the sail edge channel so that it no longer directs the lubricant into the channel.

### BRIEF SUMMARY OF THE INVENTION

The present invention provides a device for lubricating a sail edge channel. The device comprises a slide arranged for insertion into and for sliding along the channel; a reservoir for containing a lubricant; a passageway extending from the reservoir to at least one outlet; and means operable to cause the lubricant to be expelled from the reservoir into the passageway so that the lubricant is expelled from the outlet(s) into the sail edge channel.

In accordance with the innovative features of a first aspect of the invention, a web connects the slide to the reservoir and, when the slide is inserted in such a slide edge channel, extends from the slide out of the sail edge channel so that the slide can slide in the sail edge channel with the reservoir outside the sail edge channel, the outlet(s) is/are provided on the slide, and the passageway extends from the reservoir and through the web to the outlet(s) from the slide. By employing a passageway that extends through the connecting web for conveying the lubricant into the sail edge channel, rather than squirting the lubricant through the air or through a flimsy spray tube, a far more reliable method of getting the lubricant into the sail edge channel can be realised.

In accordance with the innovative features of a second aspect of the invention, the passageway extends from the reservoir to at least two such outlets which, when the slide is inserted in such a slide edge channel, are arranged at different angular positions inside the channel. More effective lubrication of the sail edge channel can therefore be achieved compared with merely directing the lubricant at the root of the sail edge channel.

It will be appreciated, of course, that the features of both aspects of the invention may be employed together.

In use, the slide of the device can be inserted into the channel, the lubricant expelling means can be operated, and the device can then be slid along the channel (for example by being hauled by a halyard or by being pushed ahead of the edge of a sail that is being hoisted) so as to lubricate the channel. In the case where the device is used with a luff channel extrusion on a forestay, there is no need to remove the extrusion from the forestay in order to lubricate it. The lubrication device can be used while the vessel is under way, for example during a change of sails during a race. In this case, the delay caused by using the device is, with one method of use, simply the time taken to insert the slide into the channel and to operate the lubricant expelling means, which is likely to be a matter of a few seconds.

At least some of the outlets are preferably arranged at different longitudinal positions along the slide or sail edge channel.

In one embodiment, the slide comprises: a central elongate body; and centralising means (such as fins, bristles, or a split sleeve of foam material) arranged around the central body for generally centralising the body in the sail edge channel. In this case, the centralising means is preferably deformable so that the device can be used with a range of cross-sectional sizes of sail edge channel.

A third aspect of the invention extends to a luff channel extrusion in combination with a device of the first and/or second aspect of the invention, the luff channel extrusion having a sail edge channel for receiving a luff of a sail and for receiving the slide of the device so that the device can slide along the sail edge channel.

A fourth aspect of the invention extends to a sailing vessel in combination with a device according to the first and/or second aspect of the invention, the sailing vessel having a sail edge channel for receiving an edge of a sail and for receiving the slide of the device so that the device can slide along the sail edge channel.

### BRIEF DESCRIPTION OF THE SEVERAL VIEWS OF THE DRAWINGS

FIG. 1 is side view of a sailing vessel with which the embodiment of the invention may be used;

FIG. 2 is a sectioned view on a larger scale of a forestay-mounted luff channel extrusion, taken on the section line 2-2 in FIG. 1;

FIG. 3 is a sectioned view on a larger scale of a mast having a luff channel, taken on the section line 3-3 in FIG. 1;

FIG. 4 is an exploded, longitudinally-sectioned view of an embodiment of lubrication device that may be used with the vessel of FIG. 1;

FIG. 5 is an assembled side view of the lubrication device;

FIG. 6 is a plan view of the device;

FIG. 7 is a sectioned view of the device, taken on the section line 7-7 in FIG. 6;

FIG. 8 is a cross-sectioned view of the device, taken on the section line 8-8 in FIG. 7;

FIGS. 9A-9D are partial sectioned views taken on the section lines A to D, respectively, in FIG. 5;

FIG. 10 is similar to FIG. 7, but after the device has been triggered;

FIG. 11 is a plan view of the device inserted into the forestay-mounted luff channel of FIG. 3; and

FIG. 12 is similar to FIG. 1, but showing the lubrication device in use.

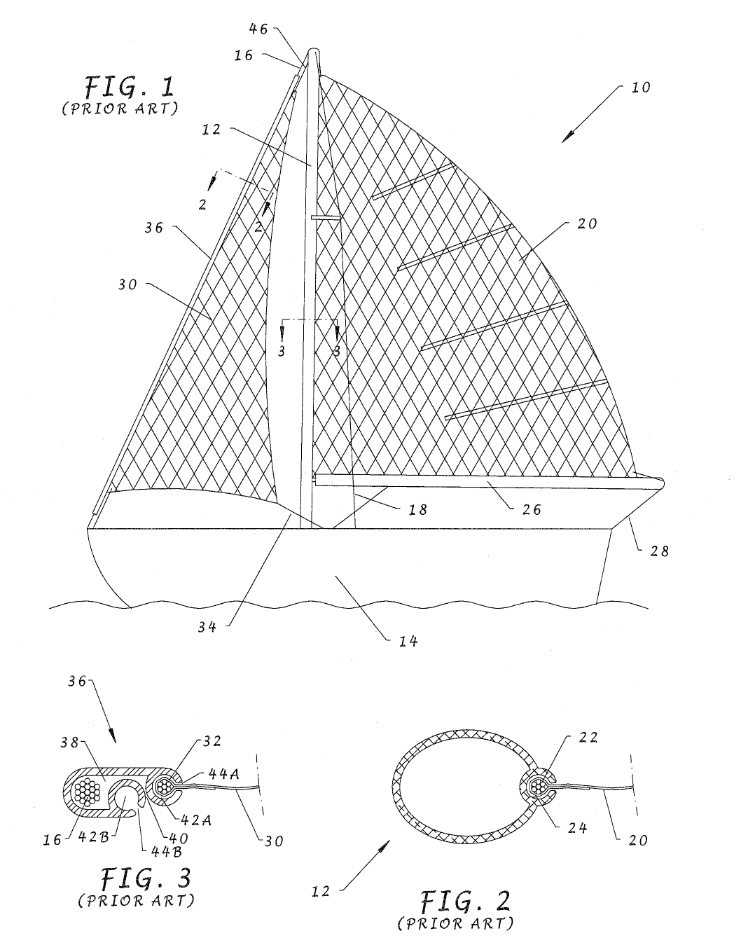

### DETAILED DESCRIPTION OF THE INVENTION

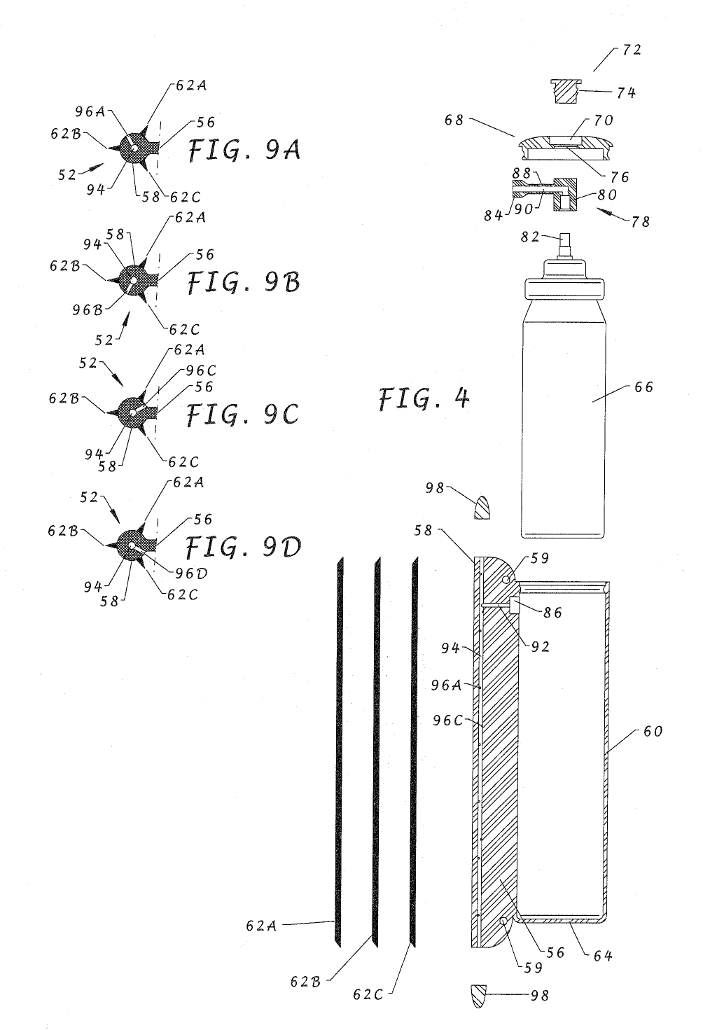

Referring to FIGS. 4 to 12 of the drawings, the lubrication device 50 of the embodiment of the invention comprises a slide portion 52, a reservoir portion 54 and a web 56 interconnecting the slide and reservoir portions 52,54. The slide portion 52 comprises a slender elongate cylindrical pig 58 having an external diameter which is about 40% of the internal diameter of the luff channels 42A,B with which the device 50 is typically intended to be used. The web 56 extends radially from the pig 58 and has a thickness that is less than the width of the slits 44A,B in the luff channels 42A,B with which the device 50 is typically intended to be used. The web 56 has holes 59 adjacent its ends. The reservoir portion 54 has an elongate cylindrical housing 60 extending generally parallel to the pig 58. The pig 58 can therefore be inserted into one end of a luff channel 42A,42B with the web 56 extending outwards through the slit 44A,B, and the device 50 can be slid along the luff channel 42A,B with the pig 58 in the channel 42A,42B, the web 56 in the slit 44A,B and the reservoir housing 60 outside the channel 42A,B.

In order generally to centralise the pig 58 in the luff channel 42A,B as viewed in FIG. 11, the pig 58 has three elongate fins 62A,B,C angularly spaced around the pig 58 by about 60, 180 and 300 degrees, respectively, with respect to the web 56. The fins 62A,B,C may be of a resilient material that is bonded to the pig 58 and which can deform when the device 50 is used with a luff channel 42A,B having a small internal diameter but still allow the device 50 to slide along the channel 42A,B.

The reservoir main housing 60 has a closed bottom 64 and contains a mini-aerosol 66 of the sort typically used for inhalers and breath fresheners. The aerosol 66 contains, for example, 15 ml of a marine lubricant such as Sailcote. The upper end of the housing 60 is closed by a cap 68 that is a snap fit with the housing 60. The cap 68 has a central aperture 70 containing an operating button 72. The operating button 72 and the cap 68 around the aperture 70 have complementary surface formations 74,76 (see FIG. 4) such that, before use of the device 50, the button 72 is held in the position shown in FIG. 7 with the upper surfaces of the cap 68 and button 72 level, but, upon manual depression of the button 72 to the position shown in FIG. 10, the button 72 remains in that depressed position.

The reservoir housing 60 also contains a connector element 78 of resilient material. The connector element has: an end portion 80 that sealingly fits over the nozzle 82 of the aerosol 66 and abuts the underside of the button 72; an end portion 84 that sealingly fits into a recess 86 in the side wall of the of the reservoir housing 60 aligned with the web 56; a flexible connecting portion 88 extending between the end portions 80,84; and a passageway 90 connecting the nozzle 82 of the aerosol 66 to the recess 86 in the reservoir housing 66. In the position of the cap 68 shown in FIG. 7, the end portion 80 of the connecting element 78 does not apply any significant pressure on the aerosol nozzle 82 and the internal valve of the aerosol 66 remains closed. However, upon depression of the button 72 to the position shown in FIG. 10, the end portion 80 of the connecting element 78 forces the aerosol nozzle 82 downwards so that the valve opens and lubricant is forced by the propellant in the aerosol 66 out through the nozzle 82 and the passageway 90 until the aerosol 66 is empty.

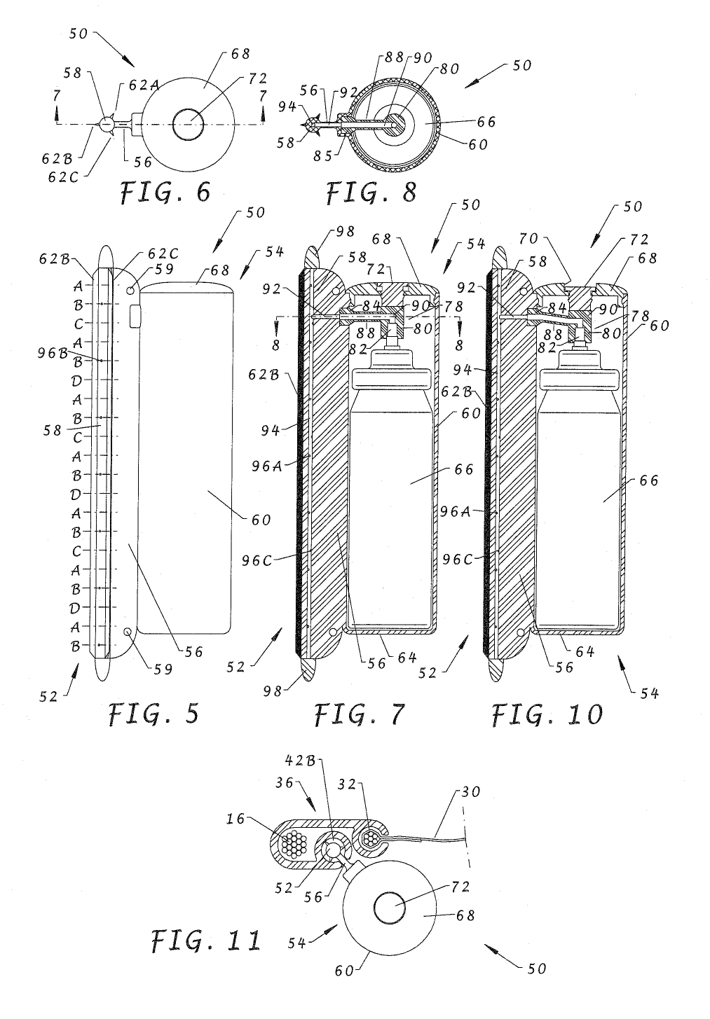

A passageway 92 is formed in the web 56 aligned with the passageway 90 in the connecting element. The passageway 92 connects with a passageway 94 extending longitudinally and centrally along the pig 58 from near its upper end to near its lower end. A series of radial passageways 96A-D then extend radially from the central passageway 94 to the outer surface of the pig 58. About one third of the radial passageways 96A, lying on the section planes A in FIG. 5 and shown also in FIG. 9A, exit between the fins 62A,62B. About another third of the radial passageways 96B, lying on the section planes B in FIG. 5 and shown also in FIG. 9B, exit between the fins 62B,62C. About one sixth of the radial passageways 96C, lying on the section planes C in FIG. 5 and shown also in FIG. 9C, exit between the fin 62A and the web 56. The remainder of the radial passageways 96D, lying on the section planes D in FIG. 5 and shown also in FIG. 9D, exit between the fin 62C and the web 56. Accordingly, when the device 50 is inserted into a luff channel 42A,B and lubricant is expelled from the aerosol 66 into the passageway 90, it passes into the passageway 92, then into the longitudinal passageway 94 in the pig 58 and is then expelled through the multiple radial passageways 96A-D into contact with the inner surface of the luff channel 42A,B. If the device 50 is then slid along the luff channel extrusion 36 from one end to the other, substantially the whole of the inner surface of the luff channel 42A,B in question will become coated with lubricant. The passageways in the device may be formed with a restriction to ensure that the lubricant is not expelled too quickly so that the aerosol 66 lasts at least for the time that it would typically take to slide the device 50 from one end of the luff channel extrusion 36 to the other.

The pig 58, web 56, reservoir main body 60, cap 68 and operating button 72 may be made of any convenient material using any convenient manufacturing process. For example, they may be injection-moulded in plastics material. The pig 58, web 56 and reservoir main body 60 may be integrally moulded, in which case end pieces 98 may be bonded to the ends of the pig 58 in order to close the ends of the longitudinal passageway 94. Alternatively, the pig 58, web 56 and reservoir main body 60 may be moulded as two symmetrical halves that are bonded together.

The devices 50 may be used in a number of ways to lubricate the luff channels 42A,B.

With a first method, which is particularly suited for lubricating a luff channel 42A,B before a sail 30 needs to be hoisted, the slide 52 is inserted into the lower end of the luff channel 42A,B, the headsail halyard 46 is attached to the upper hole 59 in the web 56, and a spare rope is attached to the web 56 through its lower hole 59. The button 72 is then pressed to commence discharge of the lubricant, and the device 50 is hauled up the luff channel extrusion 36 by the headsail halyard 46, lubricating the luff channel as it goes. Once the device 50 has reached the top of the luff channel extrusion 36, it is hauled down again using the spare rope.

With a second method which is employed when a headsail 30 is being hoisted, the slide 52 is inserted into the lower end of the luff channel 42A,B, followed by the head of the luff 32 of headsail 30 with the headsail halyard attached to the head of the headsail 30. The lanyard shackle is also attached by a short length of rope to the web 56 through the lower hole 59. The button 72 is then pressed to commence discharge of the lubricant, and the headsail 30 is hoisted by the headsail halyard 46, with the device being pushed up the luff channel 42A,B ahead of the luff 32 of the headsail 30 lubricating the luff channel 42A,B as it goes. When the headsail 30 is subsequently dropped, it draws the device 50 back down the luff channel 42A,B due to the rope attachment.

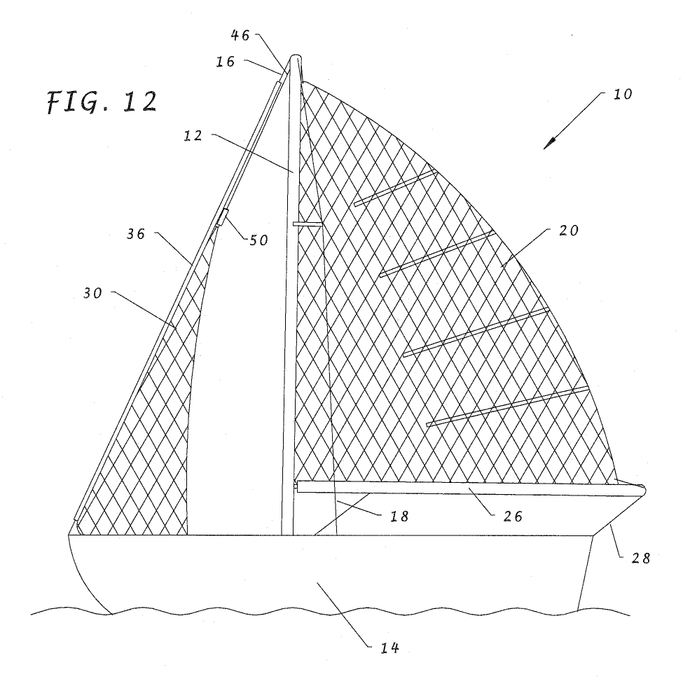

A third method is similar to the second method and may be used when the luff channel 42A,B has an open top past which the luff 32 of the headsail 30 extends when the headsail 30 is fully hoisted. In this case, the web 56 is not attached to the headsail shackle, and device 50 is ejected from the top of the luff channel 42A,B, once the headsail 30 is, or is near to being, fully hoisted, and falls to the deck below. FIG. 12 illustrates this method at the point where the headsail 30 is about two-thirds hoisted.

It will be appreciated that may modifications and developments may be made to the embodiment of the invention described above.

For example, in the case where the device 50 is to be used with only one cross-sectional size of luff channel 42A,42B, the fins 62A-C need not be of resilient material and may be integrally moulded with the pig 58. The fins 62A-C may be replaced by some other means to enable the inner surface of the luff channel to be substantially completely coated with lubricant whilst centralising the pig 58 in the luff channel 42A,B, for example bristles or a split sleeve of open-cell foam material.

Instead of employing an aerosol 66 containing the lubricant, a spring-loaded bladder or spring-loaded piston-and-cylinder arrangement may be employed. In this case, all or substantially all of the components of the device 50 may be made from biodegradable materials so as to reduce the adverse effects on the environment if the device 50 is dropped in the water.

Instead of providing holes 59 in the web 56, the device 50 may be provided with integrally-moulded tethers with loops at their ends by which the device 50 may be directly attached to the shackle of the headsail halyard 46 or to a length of spare rope.

The top 68 and bottom 64 of the reservoir 54 are shown in the drawings as being generally flat. Alternatively, they may be domed or tapered so that, when two devices 50 are being used in two luff channels 42A,B and moving in opposite directions, there is less risk that the devices 50 will jam with each other as they pass each other.

Although the device 50 was originally conceived for lubricating a luff channel 42A,B in a luff channel extrusion 36 as described in detail with reference to the drawings, it may also be used for lubricating other sail edge channels, as mentioned at the beginning of this specification.

It should be noted that the embodiment of the invention has been described above purely by way of example and that many other modifications and developments may be made thereto within the scope of the present invention.

1. A device for lubricating a sail edge channel, the device comprising:
a slide arranged for insertion into and for sliding along the channel;
a reservoir for containing a lubricant;
a web connecting the slide to the reservoir and for extending from the slide out of the sail edge channel so that the slide can slide in the sail edge channel with the reservoir outside the sail edge channel;
a passageway extending from the reservoir and through the web to at least one outlet from the slide; and
means operable to cause the lubricant to be expelled from the reservoir into the passageway so that the lubricant is expelled from the outlet into the sail edge channel.

2. A device as claimed in claim 1, wherein the slide has a plurality of such outlets for expelling lubricant into the sail edge channel.

3. A device as claimed in claim 2, wherein at least some of the outlets are arranged at different angular positions around the slide.

4. A device as claimed in claim 2, wherein at least some of the outlets are arranged at different longitudinal positions along the slide.

5. A device as claimed in claim 1, wherein the slide comprises:
a central elongate body; and
centralising means arranged around the central body for generally centralising the body in the sail edge channel.

6. A device as claimed in claim 5, wherein the centralising means is deformable.

7. A luff channel extrusion in combination with a device as claimed in claim 1, the luff channel extrusion having a sail edge channel for receiving a luff of a sail and for receiving the slide of the device so that the device can slide along the sail edge channel.

8. A sailing vessel in combination with a device as claimed in claim 1, the sailing vessel having a sail edge channel for receiving an edge of a sail and for receiving the slide of the device so that the device can slide along the sail edge channel.

9. A device for lubricating a sail edge channel, the device comprising:
a slide arranged for insertion into and for sliding along the channel;
a reservoir for containing a lubricant;
a passageway extending from the reservoir to at least two outlets which, when the slide is inserted into the channel, are disposed in the channel and arranged at different angular positions in the channel; and
means operable to cause the lubricant to be expelled from the reservoir into the passageway so that the lubricant is expelled from the outlets into the sail edge channel.

10. A device as claimed in claim 9, and having further outlets which, when the slide is inserted into the channel, are arranged at different longitudinal positions along the channel.

11. A device as claimed in claim 9, wherein the slide comprises:
a central elongate body; and
centralising means arranged around the central body for generally centralising the body in the sail edge channel.

12. A device as claimed in claim 11, wherein the centralising means is deformable.

13. A luff channel extrusion in combination with a device as claimed in claim 9, the luff channel extrusion having a sail edge channel for receiving a luff of a sail and for receiving the slide of the device so that the device can slide along the sail edge channel.

14. A sailing vessel in combination with a device as claimed in claim 9, the sailing vessel having a sail edge channel for receiving an edge of a sail and for receiving the slide of the device so that the device can slide along the sail edge channel.

15. A device for lubricating a sail edge channel, the device comprising:
a slide arranged for insertion into and for sliding along the channel;
a reservoir for containing a lubricant;
a web connecting the slide to the reservoir and for extending from the slide out of the sail edge channel so that the slide can slide in the sail edge channel with the reservoir outside the sail edge channel;
a passageway extending from the reservoir and through the web to at least two outlets from the slide arranged at different angular positions around the slide; and
means operable to cause the lubricant to be expelled from the reservoir into the passageway so that the lubricant is expelled from the outlets into the sail edge channel.

16. A device as claimed in claim 15, and having further outlets arranged at different longitudinal positions along the slide.

17. A device as claimed in claim 15, wherein the slide comprises:
a central elongate body; and
centralising means arranged around the central body for generally centralising the body in the sail edge channel.

18. A device as claimed in claim 17, wherein the centralising means is deformable.

19. A luff channel extrusion in combination with a device as claimed in claim 15, the luff channel extrusion having a sail edge channel for receiving a luff of a sail and for receiving the slide of the device so that the device can slide along the sail edge channel.

20. A sailing vessel in combination with a device as claimed in claim 15, the sailing vessel having a sail edge channel for receiving an edge of a sail and for receiving the slide of the device so that the device can slide along the sail edge channel.
